(19) United States
(12) Patent Application Publication
(10) Pub. No.: US 2014/0111432 A1
(43) Pub. Date: Apr. 24, 2014

(54) INTERACTIVE MUSIC PLAYBACK SYSTEM

(71) Applicant: SK DIGITAL GESTURE, INC., Chicago, IL (US)

(72) Inventor: Samy Kamkar, Marina Del Rey, CA (US)

(73) Assignee: SK Digital Gesture, Inc., Chicago, IL (US)

(21) Appl. No.: 13/657,360

(22) Filed: Oct. 22, 2012

(51) Int. Cl. G06F 3/033

(52) U.S. Cl. 345/158

(57) ABSTRACT

An interactive music method for controlling a media player device is provided. The interactive music method comprises the steps of receiving one or more gestures, interpreting the gesture in accordance with a plurality of predefined gestures, and executing at least one process corresponding to the gesture. The process comprises controlling audio for a specific amount of time.

### CROSS-REFERENCE TO RELATED APPLICATIONS

Not Applicable.

### FEDERALLY SPONSORED RESEARCH OR DEVELOPMENT

Not Applicable.

### MICROFICHE/COPYRIGHT REFERENCE

Not Applicable.

### FIELD OF THE INVENTION

The invention relates to an interactive music generation and playback system utilizing gestures.

### BACKGROUND OF THE INVENTION

The present invention relates generally to an interactive music generation and playback system which utilizes three types of gestures. A disc jockey (DJ) typically selects and plays music in bars, nightclubs, parties, live shows, and the like. DJs can select and play music and can employ different techniques to mix and blend music such as using one or more turntables.

Several techniques can be used by DJs as a means to better mix and blend recorded music. These techniques include the cueing, equalization, and audio mixing of two or more sound sources. The complexity and frequency of special techniques depends largely on the setting in which a DJ is working. Such techniques may include phrasing, slip-cueing, beatmatching and others. In addition, some DJs may use harmonic mixing to identify and choose songs that are in compatible musical keys.

A DJ often needs to acquire great instrument control to accommodate the problems of playing an unpredictable and unreliable instrument such as the turntable and to control the numerous switches and other inputs in the typical DJ environment. The stationary nature of the numerous controls restricts the DJ's ability to use more than a couple of controls at the same time and limits the DJ's ability to move around to access additional switches and inputs. Due to this complexity, a DJ may be limited in the number and types of techniques he can use to mix and blend music all leading to less than desired effects.

Many times this complexity results in the inability of the DJ to be able to control multiple instruments and controls at the same time. As such, a need remains to improve the ability of DJs to mix and blend music together in a way which produces the sounds effects desired with fewer drawbacks as compared to the above described traditional system.

### SUMMARY OF THE INVENTION

In accordance with one feature of the invention, an interactive music method for controlling a media player device is provided. The interactive music method comprises the steps of receiving one or more gestures, interpreting the gesture in accordance with a plurality of predefined gestures, and executing at least one process corresponding to the gesture. The process comprises controlling audio for a specific amount of time.

In one feature, the method includes one of playing a MIDI note for a specific amount of time.

In another feature, the method includes one of changing a specific MIDI control.

In another feature, the predefined gestures comprises at least one of a range gesture, a stomp gesture, or a distance gesture.

In another feature, the range gesture is interpreted based upon spatial locations.

In another feature, the distance gesture is interpreted based on spatial differentiations.

In another feature, the stomp gesture is interpreted based upon temporal and spatial differentiations.

In one feature, the gesture is received via a camera input device.

### DETAILED DESCRIPTION OF THE ILLUSTRATED EMBODIMENT

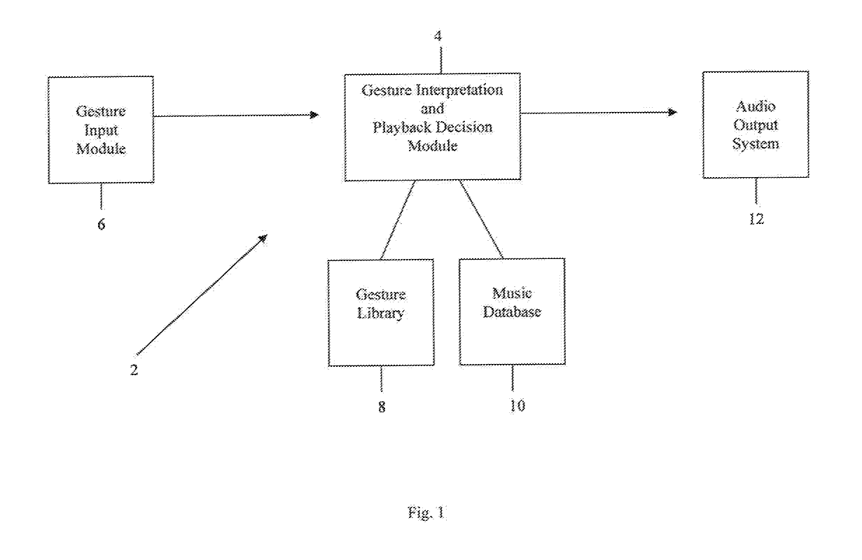

Referring to FIG. 1, there is shown a high level diagram of an interactive music playback system 2. The system 2 can be implemented in software on a general purpose or specialized computer and comprises a number of separate program modules, The music playback is controlled by a playback module 4. A gesture input module 6 receives and characterizes gestures entered by a user and provides this information to the playback module 4. Various types of gesture input devices can be used to capture the basis gesture information. In one embodiment, a conventional three-dimensional input device is used, such as a camera. Any suitable device or combination of input devices can be used, including, but not limited to, the commercially available Kinect, Wii Remote Plus, and PlayStation Move devices.

Gesture library 8 is used by the playback module 4 to appropriately select or alter the playback of music contained in the music database 10. The meaning attributed to a specific gesture, as described in detail below, can be determined with reference to data stored in the gesture library 8. The gestured controlled music and/or video is then output to an audio system 12.

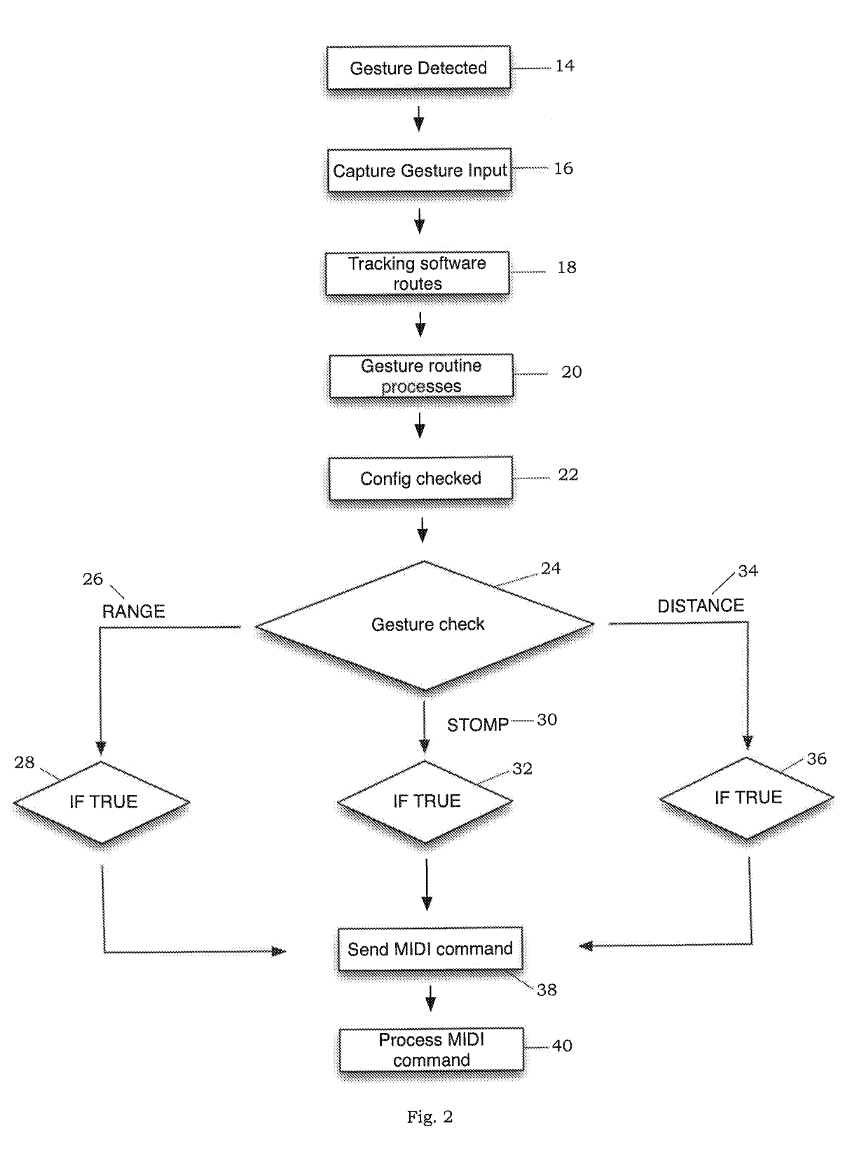

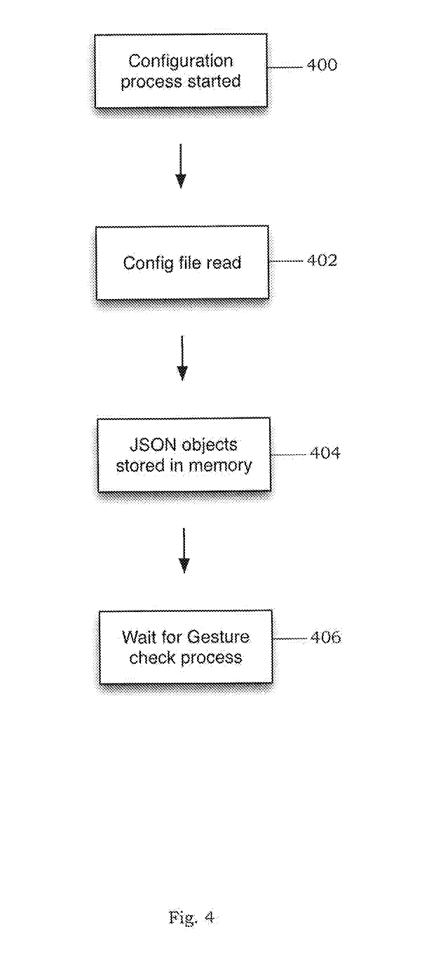

With reference to FIGS. 2-4, a series of flow diagrams illustrate software routines implemented via the playback module 4 of FIG. 1. With initial reference to FIG. 2, the general operation of one embodiment of the music playback system is shown. Initially, the gesture is detected at block 14. The gesture is initiated by the gesture input module 6 of FIG. 1 detecting movements by a user. The gesture input module 6 detects and measures the spatial location of the limbs using the X, Y, and Z coordinate system. As depicted in block 16, the gesture input module 6 captures the gesture and outputs to a tracking software depicted by block 18 which processes the output from the gesture input module 6.

Thereafter, as depicted by blocks 20 and 22, the tracking software interprets the output from the gesture input module 6 and provides position data, including the position of the user's various limbs on the X, Y, and Z axis, to block 24. In one embodiment, the position data supplied by the tracking software is provided on a scale with a range from 0-100 where the specific range indicates the position of a user's various limbs. Commercially available tracking software OSCeleton, OpenNI, SensorKinect and NITE can be used to interpret the output from the gesture input module 6 and provide position data to block 24.

As described below, this routine is repeated until one of a range, stomp or distance gesture is detected by the gesture interpretation module 4 shown by block 16. During the gesture capture period, the gesture input is analyzed concurrently with its capture and the analysis is completed when one of a range, stomp or distance gesture is detected.

Various gesture parameters can be generated from the gesture input device 6. In the preferred embodiment, based upon the gesture detected by the gesture input module 6, the gesture data is parsed into values which indicate one of a range, stomp or distance gesture.

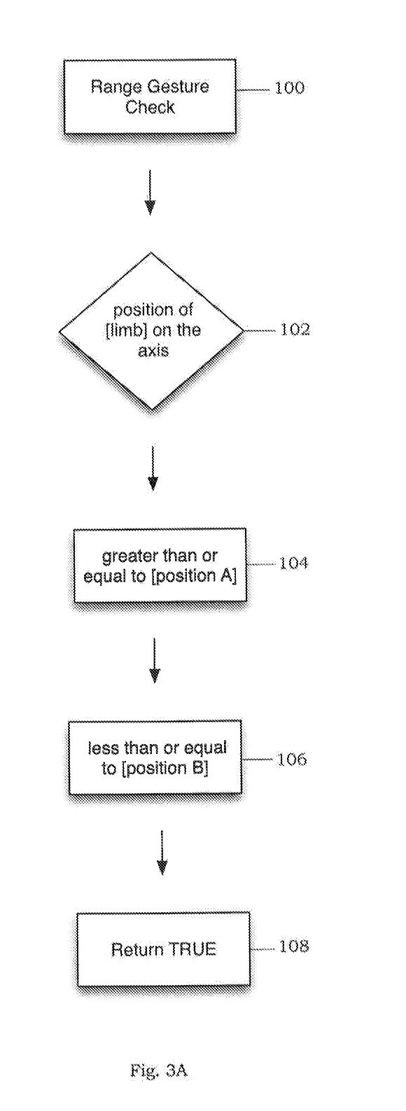

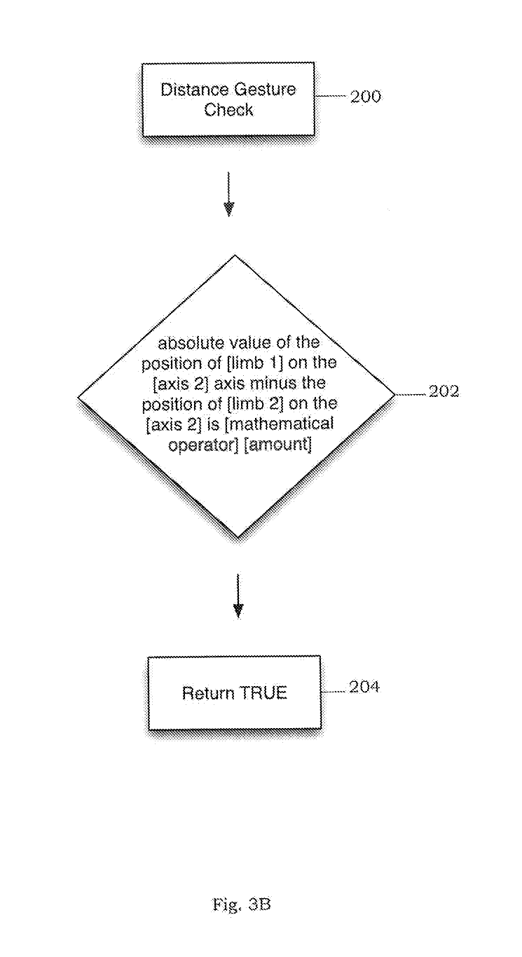

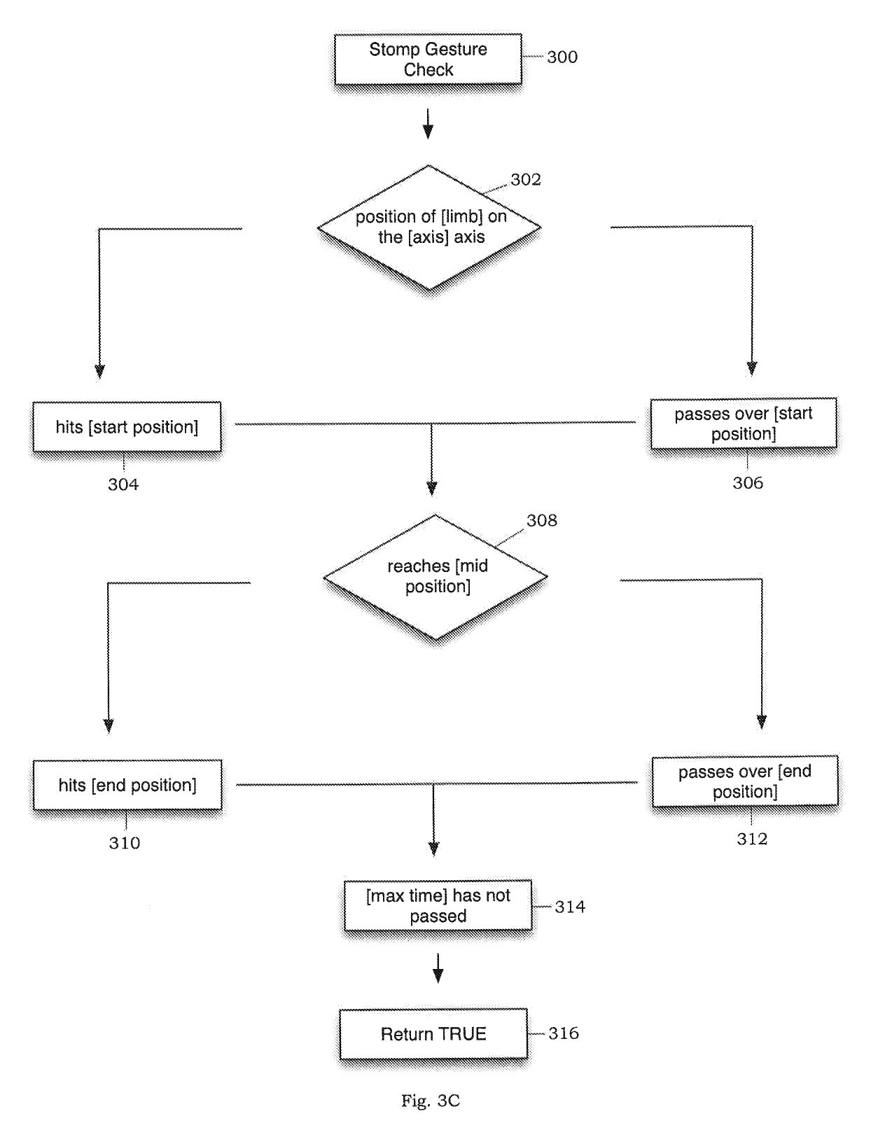

Referring to FIG. 3A, a flow diagram illustrates a range gesture check subroutine run at the block 24 of FIG. 2. Generally, a range gesture occurs and is triggered when the gesture input module 6 is within a certain predefined spatial range. More specifically, the routine begins at block 102 which determines the position of the user's limb on the X, Y, and Z axis. Decision blocks 104 and 106 determine if the position of block 102 is greater than or equal to a first position or less than or equal to a second position. If the range gesture check 100 is true, then a routine according to blocks 38 and 40 of FIG. 2 is implemented and control returns to block 16.

In one embodiment, a first position A and a second position B are each measured on a scale of 0-100. if the spatial position of the gesture input module 6 on the X, Y, and Z axis is greater than or equal to position A and less than or equal to position B, the range gesture is true and the routine, as described above, is implemented. For instance, in one embodiment, the range gesture is true if the spatial measurement of position A is 50 and the spatial measurement of position is 75. As will be appreciated by one of ordinary skill in the art, multiple different parameters for position A and position B could be used to indicate that a range gesture has occurred depending upon the requirements of the user.

Referring to FIG. 3B, a flow diagram illustrates a distance gesture check subroutine run at the block 24 of FIG. 2. Generally, a distance gesture occurs and is triggered when the gesture input module detects when one limb of a user is a certain distance from another limb on the same or different axis.

More specifically, the routine begins at block 202 which determines the absolute value of the spatial position of a first limb on the X, Y, Z axis minus the spatial position of a second limb to determine the distance between limbs. If the limbs are a predetermined distance from each other, the distance gesture check 200 is true and a routine according to block 38 of FIG. 2 is implemented and control returns to block 16.

Referring to FIG. 3C, a flow diagram illustrates a stomp gesture check subroutine run at block 24 of FIG. 2. Generally, a stomp gesture occurs and is triggered when the gesture input module 6 determines a limb travels a predetermined distance within a predetermined time.

More specifically, the routine begins at block 302 which determines an initial position of a limb on the X, Y, Z axis. Blocks 304, 306, 308, 310, 312, and 314 depict how the system 2 determines if the position of a limb calculated by the gesture input module 6 on the X, Y, Z axis travels spatially through a position A, a position B, and then a position C all within a specified time period. If the sequence of events occurs as depicted via blocks 304-314, the distance gesture check 200 is true and a routine according to block 38 of FIG. 2 is implemented and control returns to block 16.

In one embodiment, the stomp gesture occurs when a limb, as measured by the gesture input module 6, travels spatially through a start position, a mid position, and an end position where the limb generally travels in a first direction from a start position to a mid position and then generally travels in the opposite direction until reaching an end position, all within a predetermined amount of time. This gesture occurs, for example, when a user of the interactive music playback system 2 stomps its foot against a floor or other structure. It should be appreciated that many different types of stomps, which fall within the description herein, can be programmed depending upon the needs of the user.

Referring again to FIG. 2, once one of a stomp, distance, or range gesture is triggered, as depicted by blocks 28, 32 and 36, the gesture interpretation and playback decision module 4, as depicted by blocks 38 and 40, executes at least one process corresponding to the gesture identified.

In one embodiment, these processes include controlling audio for a specific predetermined amount of time. For example, such process parameters can include the fading of audio, the volume of audio, the pace of audio. In addition, the parameters can also include repeating a specified beat in a loop pattern as well as delay effects such as reverbs and echoes.

In one embodiment, the MIDI protocol is used to control the audio while in another embodiment, the Open Sound Control (OSC) protocol is used to control audio. As one of ordinary skill in the art will appreciate, there will be a multitude of different parameters which can be applied as required by the specific application. In addition, any other protocol which generates or plays audio such to accomplish the needs of the user may be used. The routine reads from the music database 10. From block 40, the routine returns to block 14 of FIG. 2 as described above.

I claim:

1. An interactive music method for controlling a media player device comprising the steps of:
receiving one or more gestures;
interpreting the gesture in accordance with a plurality of predefined gestures;
executing at least one process corresponding to the gesture;
wherein the process comprises controlling audio for a specific amount of time.

2. The method of claim 1 further comprising one of playing a MIDI note for a specific amount of time.

3. The method of claim 1 further comprising changing a specific MIDI control.

4. The method of claim 1 wherein the predefined gestures comprises at least one of a range gesture, a stomp gesture, or a distance gesture.

5. The method of claim 4 wherein the range gesture is interpreted based upon spatial locations.

6. The method of claim 4 wherein the distance gesture is interpreted based on spatial differentiations.

7. The method of claim 4 wherein the stomp gesture is interpreted based upon temporal and spatial differentiations.

8. The method of claim 4 wherein the gesture is received via a camera input device.
